(19) United States
(12) Patent Application Publication
(10) Pub. No.: US 2025/0142670 A1
(43) Pub. Date: May 1, 2025

(54) METHOD AND APPARATUS FOR MANAGING DRX OPERATION OF UE RECEIVING NR MBS

(71) Applicant: SAMSUNG ELECTRONICS CO., LTD., Suwon-si, Gyeonggi-do (KR)

(72) Inventors: Vinay Kumar SHRIVASTAVA, Bangalore (IN); Sangkyu BAEK, Suwon-si (KR)

(21) Appl. No.: 18/836,692

(22) PCT Filed: Feb. 9, 2023
(86) PCT No.: PCT/KR2023/001905

§ 371 Date: Aug. 7, 2024

(30) Foreign Application Priority Data
Feb. 9, 2022 (IN) 202241006836
Jan. 20, 2023 (IN) 202241006836

(51) Int. Cl. H04W 76/28; H04W 76/38

(52) U.S. Cl. CPC H04W 76/28; H04W 76/38

(57) ABSTRACT

The disclosure relates to a 5G or 6G communication system for supporting a higher data transmission rate. Embodiments herein disclose a method and a system for availing discontinuous reception (DRX) command for a plurality of User Equipments (UEs) receiving New Radio Multicast Broadcast Service (NR MBS). The method includes receiving medium access control (MAC) control element (CE) (320) from a base station. The MAC CE (320) comprises at least one of a Channel Identifier (ID), a DRX index, and a Radio Network Temporary Identifier (RNTI). The method includes determining that the received MAC CE (320) comprises a DRX command for at least one MBS service based on the at least one of the Channel ID, the DRX index and the RNTI. The DRX command is for stopping at least one timer of DRX configuration of the at least one MBS service. The method includes stopping the at least one timer of DRX configuration of the at least one MBS service based on the determination.

### TECHNICAL FIELD

The present disclosure relates to wireless communication, and more particularly to a method and a system for managing Discontinuous Reception (DRX) operation of User Equipment (UE) receiving New Radio (NR) Multicast Broadcast Service (MBS).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In wireless communication systems, a New Radio Multicast Broadcast Service (NR MBS) services refer to multicast services where intended common contents are delivered to a group of User Equipments (UEs) that joins a multicast group in a multicast coverage area. In broadcast services, the intended contents are delivered to all the UEs in a broadcast coverage area. The broadcast coverage area can be one cell or more cells.

Two delivery methods are envisioned for Fifth-Generation (5G) MBS service, namely an individual MBS traffic delivery method and a shared MBS traffic delivery method from a view point of 5G Core Network (CN). For the individual MBS traffic delivery method, the 5G CN receives a single copy of MBS data packets and delivers separate copies of the MBS data packets to the individual UEs via per-UE Protocol Data Unit (PDU) sessions. For the shared MBS traffic delivery method, the 5G CN receives the single copy of the MBS data packets and delivers the single copy of the MBS data packets to a Radio Access Node (RAN), which then delivers the single copy of the MBS data packets to one or multiple UEs. The RAN delivers the MBS data packets to the UEs using either Point-to-Point delivery (PTP) or Point-to-Multipoint (PTM) delivery. PTP is data transmission to a single target UE in the MBS. PTM is the data transmission to multiple target UEs in the MBS. Further, at the UE, a MBS bearer is composed of a common Protocol Data Convergence Protocol (PDCP) entity with PTP, PTM or a combination of PTP and PTM legs or Radio Link Control (RLC) entities (also termed as MBS split bearer).

For the purpose of power saving and efficient scheduling, MBS reception is associated with a session specific Discontinuous Reception (DRX) approach. The DRX approach/operation is defined with certain DRX timers which define a procedure to control the DRX operation for a specific MBS session reception. However, one consequence is that even though network is better aware about present and/or future data scheduling for the MBS service for the UE, an immediate sleep operation is not possible for the UE given the finite duration for the DRX timers. Thereby, leading to associated delays to do transition across a wake up mode and a sleep mode of the DRX for the UE.

Moreover, when compared to unicast DRX, the MBS DRX operation poses new challenges and complexities. They are as follows:

When considering multiple groups of the MBS services, each group of the MBS services has to be identified by a Group-Radio Network Temporary Identifier (G-RNTI). Thus, multiple G-RNTIs have to be configured for the UE.

Each G-RNTI should have its own MBS DRX configuration and operation including the HARQ.

For the UE power saving, the network (base station or next generation NodeB, gNB) may want to control the UE's multiple DRX operations about sleep/awake time efficiently.

Thus, it is desired to address the above mentioned disadvantages or other shortcomings or at least provide a useful alternative.

### DISCLOSURE OF INVENTION

### Technical Problem

Advantages, and salient features of the invention will become apparent to those skilled in the art from the following detailed description, which, taken in conjunction with the annexed drawings, discloses exemplary embodiments of the invention. For more enhanced communication system, there is a need for method and apparatus for managing DRX operation of UE receiving NR MBS.

### Solution to Problem

The principal object of the embodiments herein is to provide a method and a system for managing Discontinuous Reception (DRX) operation of User Equipment (UE) receiving New Radio (NR) Multicast Broadcast Service (MBS).

The method includes determining whether a medium access control (MAC) control element (CE) comprises a DRX command for at least one MBS service based on one of a Channel identifier ID, a DRX index and Radio Network Temporary Identifier (RNTI). The DRX command is for stopping a timer of DRX configuration of the MBS service.

Another object of the embodiments herein is to determine services (unicast service or MBS service) availed by the UEs and start/stop at least one timer of the DRX configuration of the UE to initiate a wake up mode or a sleep mode in the UE based on the determined DRX command.

### Advantageous Effects of Invention

The proposed method provides several solutions to issue the DRX command to the plurality of UEs receiving the MBS services in order to achieve quicker and efficient DRX operation for the UE.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a block diagram of a User Equipment (UE) of a system for managing Discontinuous Reception (DRX) operation of User Equipment (UE) receiving New Radio (NR) Multicast Broadcast Service (MBS), according to the embodiments as disclosed herein;

FIG. 2 is a flow chart illustrating a method for managing the DRX operation of the UE receiving NR MBS, according to the embodiments as disclosed herein;

FIG. 3 is an example of the MBS DRX Command Medium Access Control (MAC) Control Element (CE) based on a bitmap using a Logical Channel identifier (LCID) field, according to the embodiments as disclosed herein;

FIG. 4 is an example of the MBS DRX Command MAC CE based on the bitmap using an extended LCID (eLCID) field, according to the embodiments as disclosed herein;

FIG. 5 is an example of the MBS DRX Command MAC CE based on a Group-Radio Network Temporary Identifier (G-RNTI)/G-CS-RNTI and using the LCID, according to the embodiments as disclosed herein;

FIG. 6 is an example of the MBS DRX Command MAC CE based on the G-RNTI/G-CS-RNTI and using the eLCID, according to the embodiments as disclosed herein;

FIG. 7 is an example of the MBS DRX Command MAC CE indicated by PDCCH addressed to the G-RNTI/G-CS-RNTI or by downlink multicast assignment and using the LCID, according to the embodiments as disclosed herein;

FIG. 8 is an example of the MBS DRX Command MAC CE indicated by PDCCH addressed to the G-RNTI/G-CS-RNTI or by downlink multicast assignment and using the eLCID, according to the embodiments as disclosed herein; and

FIG. 9 is an example of the MBS DRX Command MAC CE across an initial transmission addressed to the G-RNTI/G-CS-RNTI and retransmission addressed to a Cell-Radio Network Temporary Identifier (C-RNTI)/CS-RNTI, according to the embodiments as disclosed herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following specification particularly describes and ascertains the nature of this invention and the manner in which it is to be performed:

In wireless communication systems, a New Radio Multicast Broadcast Service (NR MBS) services refer to multicast services where intended common contents are delivered to a group of User Equipments (UEs) that joins a multicast group in a multicast coverage area. In broadcast services, the intended contents are delivered to all the UEs in a broadcast coverage area. The broadcast coverage area can be one cell or more cells.

Two delivery methods are envisioned for Fifth-Generation (5G) MBS service, namely an individual MBS traffic delivery method and a shared MBS traffic delivery method from a view point of 5G Core Network (CN). For the individual MBS traffic delivery method, the 5G CN receives a single copy of MBS data packets and delivers separate copies of the MBS data packets to the individual UEs via per-UE Protocol Data Unit (PDU) sessions. For the shared MBS traffic delivery method, the 5G CN receives the single copy of the MBS data packets and delivers the single copy of the MBS data packets to a Radio Access Node (RAN), which then delivers the single copy of the MBS data packets to one or multiple UEs. The RAN delivers the MBS data packets to the UEs using either Point-to-Point delivery (PTP) or Point-to-Multipoint (PTM) delivery. PTP is data transmission to a single target UE in the MBS. PTM is the data transmission to multiple target UEs in the MBS. Further, at the UE, a MBS bearer is composed of a common Protocol Data Convergence Protocol (PDCP) entity with PTP, PTM or a combination of PTP and PTM legs or Radio Link Control (RLC) entities (also termed as MBS split bearer).

For the purpose of power saving and efficient scheduling, MBS reception is associated with a session specific Discontinuous Reception (DRX) approach. The DRX approach/operation is defined with certain DRX timers which define a procedure to control the DRX operation for a specific MBS session reception. However, one consequence is that even though network is better aware about present and/or future data scheduling for the MBS service for the UE, an immediate sleep operation is not possible for the UE given the finite duration for the DRX timers. Thereby, leading to associated delays to do transition across a wake up mode and a sleep mode of the DRX for the UE.

Moreover, when compared to unicast DRX, the MBS DRX operation poses new challenges and complexities. They are as follows:

When considering multiple groups of the MBS services, each group of the MBS services has to be identified by a Group-Radio Network Temporary Identifier (G-RNTI). Thus, multiple G-RNTIs have to be configured for the UE.

Each G-RNTI should have its own MBS DRX configuration and operation including the HARQ.

For the UE power saving, the network (base station or next generation NodeB, gNB) may want to control the UE's multiple DRX operations about sleep/awake time efficiently.

Thus, it is desired to address the above mentioned disadvantages or other shortcomings or at least provide a useful alternative.

Accordingly the embodiments herein disclose a method for managing Discontinuous Reception (DRX) operation of User Equipment (UE) receiving New Radio (NR) Multicast Broadcast Service (MBS). The method includes receiving medium access control (MAC) control element (CE) from a base station. The MAC CE includes at least one of a Channel Identifier (ID), a DRX index, and a Radio Network Temporary Identifier (RNTI). The method includes determining that the received MAC CE comprises a DRX command for at least one MBS service based on the at least one of the Channel ID, the DRX index and the RNTI. The DRX command is for stopping at least one timer of DRX configuration of the at least one MBS service. The method includes stopping the at least one timer of DRX configuration of the at least one MBS service based on the determination.

In an embodiment, the MAC CE is indicated by a Physical control downlink channel (PDCCH) addressed to the RNTI.

In an embodiment, the MAC CE is indicated by the PDCCH addressed to the RNTI and comprises the Channel ID.

In an embodiment, wherein the MAC CE is indicated by a configured downlink multicast assignment.

In an embodiment, the Channel ID comprises one of a Logical Channel ID (LCID) and an extended LCID (eLCID).

In an embodiment, the at least one timer comprises one of a DRX ON duration timer, a DRX inactivity timer, a DRX Hybrid Automatic Repeat Request (HARQ) Round Trip Time (RTT) timer, and a DRX HARQ Retransmission timer.

In an embodiment, determining that the received MAC CE includes the DRX command for the at least one MBS service based on the at least one of the DRX index and the RNTI includes performing one of: determining that the DRX index of the received MAC CE corresponds to DRX configuration of the at least one MBS service, and a value carried by the DRX index is equal to unity; or determining the RNTI is either addressed by the received MAC CE (320) or included in the received MAC CE (320) and corresponds to the RNTI of the at least one MBS service.

In an embodiment, the RNTI includes at least one of a Group-Radio Network Temporary Identifier (G-RNTI), a Group-Configured Scheduling-Radio Network Temporary Identifier (G-CS-RNTI), a Cell-Radio Network Temporary Identifier (C-RNTI), and a Configured Scheduling Radio Network Temporary Identifier (CS-RNTI).

In an embodiment, the RNTI either addressed by the received MAC CE or included in the received MAC CE is determined to identify the DRX command for the DRX configuration of at least one of the G-RNTI, the G-CS-RNTI, the C-RNTI and the CS-RNTI.

In an embodiment, wherein identifying the DRX command for the DRX configuration of the G-RNTI or the G-CS-RNTI includes determining the DRX command is included by a MAC Protocol Data Unit (PDU) scheduled by one of the C-RNTI, the CS-RNTI and the configured downlink assignment; determining that the DRX command is transmitted as a retransmission of Point-To-Multipoint (PTM) transmission with the G-RNTI or the G-CS-RNTI; and identifying the DRX command for the DRX configuration of the G-RNTI or the G-CS-RNTI.

In an embodiment, wherein identifying the DRX command for the DRX configuration of the C-RNTI or the CS-RNTI includes determining the DRX command is included by the MAC PDU scheduled by one of the C-RNTI, the CS-RNTI and the configured downlink assignment, determining that the DRX command is transmitted as an initial transmission or retransmission with the C-RNTI or the CS-RNTI, and identifying the DRX command for the DRX configuration of the C-RNTI or the CS-RNTI to stop at least one timer of the DRX configuration of at least one DRX group for the unicast.

Accordingly the embodiments herein disclose a system for managing the DRX operation of the UE receiving the NR MBS. The system includes a memory, a processor coupled to the memory, a communicator coupled to the memory and the processor, and a DRX command controller coupled to the memory, the processor and the communicator. The DRX command controller is configured to receive the MAC CE from the base station. The MAC CE includes at least one of the Channel ID, the DRX index, and the RNTI. The DRX command controller is configured to determine that the received MAC CE comprises a DRX command for at least one MBS service based on the at least one of the Channel ID, the DRX index and the RNTI. The DRX command is for stopping at least one timer of DRX configuration of the at least one MBS service. The DRX command controller is configured to stop the at least one timer of DRX configuration of the at least one MBS service based on the determination.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiments herein disclose a method for managing Discontinuous Reception (DRX) operation of User Equipment (UE) receiving New Radio (NR) Multicast Broadcast Service (MBS). The method includes receiving medium access control (MAC) control clement (CE) from a base station. The MAC CE includes at least one of a Channel Identifier (ID), a DRX index, and a Radio Network Temporary Identifier (RNTI). The method includes determining that the received MAC CE comprises a DRX command for at least one MBS service based on the at least one of the Channel ID, the DRX index and the RNTI. The DRX command is for stopping at least one timer of DRX configuration of the at least one MBS service. The method includes stopping the at least one timer of DRX configuration of the at least one MBS service based on the determination.

Accordingly the embodiments herein disclose a system for managing the DRX operation of the UE receiving the NR MBS. The system includes a memory, a processor coupled to the memory, a communicator coupled to the memory and the processor, and a DRX command controller coupled to the memory, the processor and the communicator. The DRX command controller is configured to receive the MAC CE from the base station. The MAC CE includes at least one of the Channel ID, the DRX index, and the RNTI. The DRX command controller is configured to determine that the received MAC CE comprises a DRX command for at least one MBS service based on the at least one of the Channel ID, the DRX index and the RNTI. The DRX command is for stopping at least one timer of DRX configuration of the at least one MBS service. The DRX command controller is configured to stop the at least one timer of DRX configuration of the at least one MBS service based on the determination.

Conventional methods and systems send discontinuous reception (DRX) command to the UE. The conventional methods include determining whether to schedule the UE during a period of time; and sending an additional DRX command to the UE if the UE is not scheduled during the period of time. The additional DRX command is used to indicate that the UE executes DRX during the period of time so as to be in a sleep state. On the premise of not changing the existing DRX configuration of the UE, the conventional methods execute a new sleep pattern by triggering the additional DRX command during a small period of free time in which the UE does not send and receive a data packet.

Conventional methods and systems control DRX operation. However in the conventional methods and systems, even though a network is better aware about the present and/or future data scheduling for the MBS service(s) for the UE, an immediate sleep operation is not possible for the UE given the finite duration for the DRX timers. Thereby, leading to associated delays to do transition across a wake up mode and a sleep mode of the DRX for the UE.

Unlike the conventional methods and system, the proposed method determines the services (unicast or MBS service) provided to the UE and transmits the DRX command to the UE based on the service to stop the timer of the UE efficiently. Further, the proposed method initiates the wake up mode or the sleep mode in the UE upon the DRX command received by the UE. Thereby, achieving quicker and efficient DRX operation for the UE.

The proposed DRX approach for the MBS supports power efficient and reliable delivery of the MBS services. Further, the proposed method can be applied for multiple groups of the MBS services. Each group of the MBS services is identified by a Group-Radio Network Temporary Identifier (G-RNTI) or a Group Configured Scheduling Radio Network Temporary Identifier (G-CS-RNTI). Thus, multiple G-RNTIs/G-CS-RNTI scan be configured for the UE. Each G-RNTI/G-CS-RNTI has own MBS DRX configuration and operation including a Hybrid Automatic Repeat Request (HARQ). For the UE power saving, a network apparatus controls the UE's multiple DRX operations about sleep/awake time efficiently.

Since the UE power saving is one of the most important issues in mobile communications, the DRX can be configured for the MBS. The MBS has a dedicated DRX configuration called MBS DRX. A Radio Resource Control (RRC) controls a multicast DRX operation for Point-To-Point (PTP) and/or unicast addressed by a Cell-Radio Network Temporary Identifier (C-RNTI) or a Configured Scheduling Radio Network Temporary Identifier (CS-RNTI) by configuring the following parameters:
drx-onDurationTimer: a duration at the beginning of a DRX cycle;
drx-SlotOffset: a delay before starting the drx-onDurationTimer;
drx-InactivityTimer: the duration after a Physical Downlink Control Channel (PDCCH) occasion in which the PDCCH indicates a new Uplink (UL) or Downlink (DL) transmission for a MAC entity;
drx-RetransmissionTimerDL (per DL HARQ process except for the broadcast process): the maximum duration until a DL retransmission is received;
drx-LongCycleStartOffset: a Long DRX cycle and drx-StartOffset which defines a subframe where the Long DRX cycle and a Short DRX cycle starts;
drx-ShortCycle (optional): the Short DRX cycle;
drx-ShortCycleTimer (optional): the duration in which the UE shall follow the Short DRX cycle; and
drx-HARQ-RTT-TimerDL (per DL HARQ process except for the broadcast process): the minimum duration before a DL assignment for HARQ retransmission is expected by the MAC entity.

The RRC controls the multicast DRX operation for Point-To-Multipoint (PTM) per G-RNTI or per G-CS-RNTI by configuring the following parameters:
drx-onDurationTimerPTM: the duration at the beginning of the DRX cycle;
drx-SlotOffsetPTM: the delay before starting the drx-onDuration TimerPTM;
drx-InactivityTimerPTM: the duration after the PDCCH occasion in which a PDCCH indicates a new DL multicast transmission for the MAC entity;
drx-LongCycleStartOffsetPTM: the long DRX cycle and drx-StartOffsetPTM which defines the subframe where the long DRX cycle starts;
drx-RetransmissionTimerDL-PTM (per DL HARQ process for multicast MBS): the maximum duration until a DL multicast retransmission is received; and
drx-HARQ-RTT-TimerDL-PTM (per DL HARQ process for multicast MBS): the minimum duration before a DL multicast assignment for HARQ retransmission is expected by the MAC entity.

Active Time is a time period during which the MAC entity monitors a set of allocated RNTIs. When the multicast DRX is configured for the G-RNTI or the G-CS-RNTI, Active Time includes the time while the drx-on Duration TimerPTM or the drx-InactivityTimerPTM or the drx-RetransmissionTimerDL-PTM is running for the G-RNTI or the G-CS-RNTI.

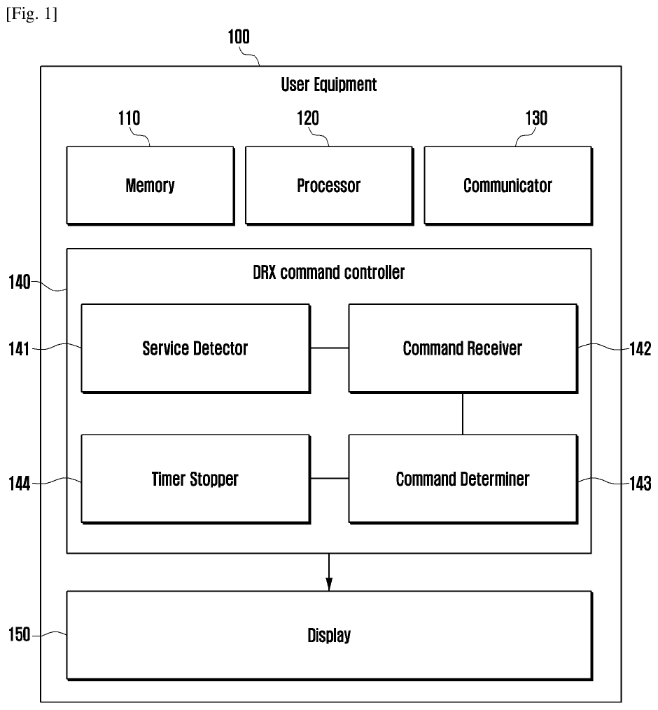

Referring now to the drawings and more particularly to FIGS. 1 through 9, where similar reference characters denote corresponding features consistently throughout the figure, these are shown preferred embodiments.

FIG. 1 is a block diagram of a User Equipment (UE) (100) included in a system for managing DRX operation of the UE receiving NR MBS, according to the embodiments as disclosed herein. The system includes a network apparatus and the UE (100). The network apparatus includes but not limited to a next generation NodeB and a gNB. The UE may be but not limited to a laptop, a palmtop, a desktop, a mobile phone, a smart phone, Personal Digital Assistant (PDA), a tablet, a wearable device, a television, a connected car, an autonomous vehicle, an Internet of Things (IoT) device, a virtual reality device, a foldable device, a flexible device, a display device, and an immersive system.

In an embodiment, the UE (100) includes a memory (110), a processor (120), a communicator (130), a DRX command controller (140) and a display (150).

The memory (110) is configured to store a listing of services such as for example but not limited to a unicast and a MBS to be received by the UE (100). The memory (110) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) is configured to store larger amounts of information. In certain examples, a non-transitory storage medium may store data that can, over time, change (e.g., in Random Access Memory (RAM) or cache).

The processor (120) may include one or a plurality of processors (120). The one or the plurality of processors (120) may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (120) may include multiple cores and is configured to determine the service received by the UE (100).

In an embodiment, the communicator (130) includes an electronic circuit specific to a standard that enables wired or wireless communication. The communicator (130) is configured to communicate internally between internal hardware components such as the memory (110), the processor (120), the DRX command controller (140) and the display (150) of the UE (100) and with external devices via one or more networks.

In an embodiment, the DRX command controller (140) includes a service detector (141), a command receiver (142), a command determiner (143), and a timer stopper (144).

In an embodiment, the service detector (141) is configured to detect the service received by the UEs (100) from the network apparatus using a Channel Identifier (ID) of a Medium Access Control (MAC) Control Element (CE). Examples of the service include but not limited to a unicast and a Multicast Broadcast Service (MBS). The MAC CE is defined as special MAC structure carrying control information during control command exchange between the UE (100) and the network apparatus. The MAC CE either addresses or includes but not limited to the Channel ID, a DRX index, and a Radio Network Temporary Identifier (RNTI).

The channel ID of the MAC CE includes but not limited to a Logical Channel ID (LCID) and/or an extended LCID (eLCID). The LCID identifies a logical channel instance of a corresponding MAC Service Data Unit (SDU) or a type of the corresponding MAC CE or padding. The eLCID extends the range of a LCID field.

The RNTI of the MAC CE is used to differentiate/identify a UE (100) of the plurality of UEs, a specific radio channel, a group of UEs in case of paging, a group of UEs for which power control is issued by the network apparatus, system information transmitted for all the UEs by the network apparatus. The RNTI includes but not limited to a Group-Radio Network Temporary Identifier (G-RNTI), a Group-Configured Scheduling-Radio Network Temporary Identifier (G-CS-RNTI), a Cell-Radio Network Temporary Identifier (C-RNTI), and a Configured Scheduling Radio Network Temporary Identifier (CS-RNTI).

In an embodiment, the command receiver (142) is configured to receive the MAC CE from the network apparatus upon determination of the service received by the UE (100).

In an embodiment, the command determiner (143) is configured to determine whether the received MAC CE is the DRX command for stopping the respective timer of the UE (100) based on the service received by the UE (100). The UE (100) includes timers such as for example but not limited to a DRX ON duration timer, a DRX inactivity timer, a DRX Hybrid Automatic Repeat Request (HARQ) Round Trip Time (RTT) timer, and a DRX HARQ Retransmission timer. The received MAC CE is determined as the DRX command based on the at least one of the conditions mentioned below:
(i) When the DRX index of the received MAC CE corresponds to DRX configuration of the MBS service, and a value carried by the DRX index is equal to one. When the value carried by the DRX index is equal to zero, the received MAC CE is not considered as the DRX command; and
(ii) When the RNTI is either addressed by the received MAC CE or included in the received MAC CE and corresponds to the RNTI of the at least one MBS service.

In an embodiment, the timer stopper (144) is configured to stop the respective timer of DRX configuration of the pertinent MBS service in response to determining that the received MAC CE is the DRX command for stopping the respective timer of DRX configuration of the pertinent MBS service.

The DRX command controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the DRX command controller (140) may be implemented through an AI model. A function associated with the AI model may be performed through memory (110) and the processor (120). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment, the display (150) is configured to display the MAC CE including the DRX index. The display (150) is implemented using touch sensitive technology and comprises one of liquid crystal display (LCD), light emitting diode (LED), etc.

Although the FIG. 1 show the hardware elements of the UE (100) but it is to be understood that other embodiments are not limited thereon. In other embodiments, the UE (100) may include less or more number of elements. Further, the labels or names of the elements are used only for illustrative purpose and does not limit the scope of the invention. One or more components can be combined together to perform same or substantially similar function.

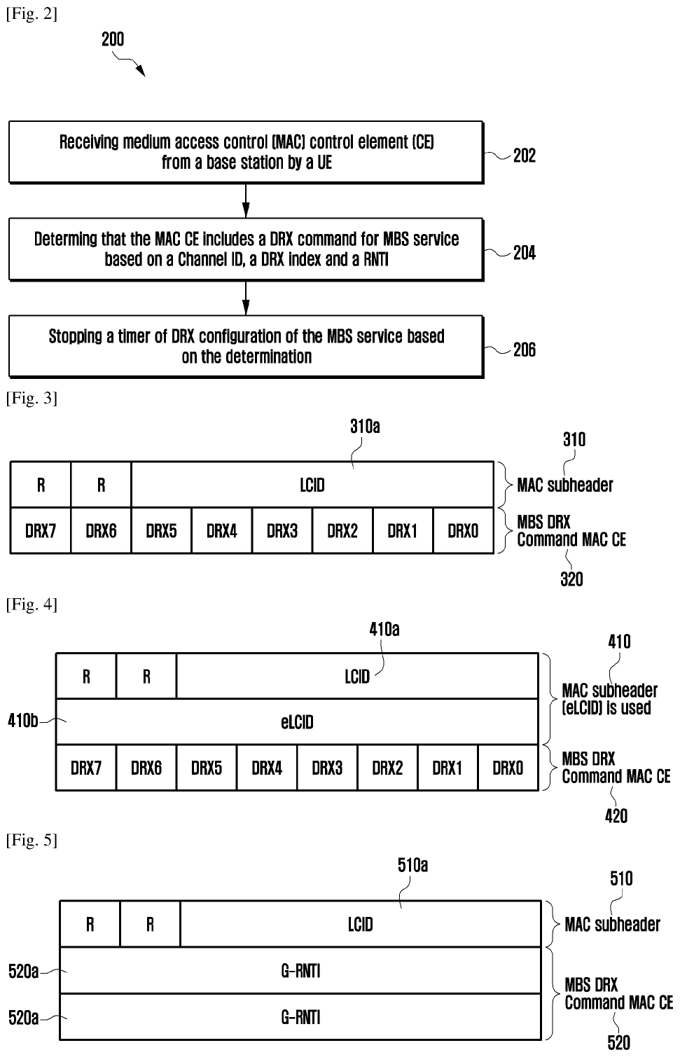

FIG. 2 is a flow chart (200) illustrating a method for managing the DRX operation of the UE (100) receiving the NR MBS, according to the embodiments as disclosed herein.

Referring to the FIG. 2, at step 202, the method includes the UE (100) receiving the MAC CE from the base station. The MAC CE includes at least one of the Channel ID, the DRX index, and the RNTI. For example, in the UE (100) as illustrated in the FIG. 1, the DRX command controller (140) is configured to receive the MAC CE from the base station.

Referring to the FIG. 2, at step 204, the method includes the UE (100) determining that the received MAC CE includes the DRX command for the MBS service based on the at least one of the Channel ID, the DRX index and the RNTI. The DRX command is for stopping the timer of DRX configuration of the MBS service. For example, in the UE (100) as illustrated in the FIG. 1, the DRX command controller (140) is configured to determine that the received MAC CE includes the DRX command for the MBS service based on the at least one of the Channel ID, the DRX index and the RNTI.

Referring to the FIG. 2, at step 206, the method includes the UE (100) stopping the timer of DRX configuration of the MBS service based on the determination. For example, in the system (100) as illustrated in the FIG. 1, the DRX command controller (140) is configured to stop the timer of DRX configuration of the MBS service based on the determination.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIG. 3 is an example of the MBS DRX Command MAC CE (320) based on a bitmap using the LCID (310a), according to the embodiments as disclosed herein.

In an embodiment, Non-zero-byte MAC CE (320) using LCID (310a): Considering a scenario where the MAC CE (320) determined as the MBS DRX command issued to the UE (100) by the network apparatus is a non-zero-byte, i.e. the MBS DRX command includes both a MAC subheader (310) with the LCID (310a) and the MAC CE (320). In such case, the MAC subheader (310) has own LCID value. The LCID value identifies the logical channel instance of the corresponding MAC SDU or the type of the corresponding MAC CE. The MAC CE (320) is transmitted to the UE (100) via a Point-To-Multipoint (PTM) transmission/retransmission by one of the G-RNTI, a MBS Semi-Persistent Scheduling (SPS) or the G-CS-RNTI. The MAC CE (320) can also be transmitted to the UE (100) via a Point-To-Point (PTP) transmission/retransmission by the C-RNTI, a unicast SPS or the CS-RNTI.

In an embodiment, the MAC CE (320) to be transmitted to the UE (100) is determined as the DRX command when the value carried by the DRX index (DRXi) of the MAC CE (320) corresponds to the DRX configuration of the MBS service, where the index is defined as ‘i’. The index i is configured by a Radio Resource Control (RRC) signaling such that a mapping exists between the index i and the G-RNTI/G-CS-RNTI or the MBS DRX configuration. Alternatively, the index i can be configured as an ascending order of a configured G-RNTI/G-CS-RNTI or a configured multicast assignment G-RNTI/G-CS-RNTI. Further, the MAC CE (320) to be transmitted to the UE (100) is determined as the DRX command when the value carried by the DRXi is equal to 1. When the value carried by the DRXi is equal to 0, then the MAC CE (320) is not considered as the DRX command for the G-RNTI/G-CS-RNTI.

Upon determining that the DRX index of the MAC CE (320) corresponds to the DRX configuration of the MBS service and the value carried by the DRX index of the MAC CE (320) is equal to 1, the MAC CE (320) is transmitted as the DRX command to the UE (100). The DRX command is transmitted to the UE (100) to stop the respective timer of the DRX configuration for the MBS service of the UE (100), in order to activate the sleep mode in the UE (100) when the UE (100) is not in use. Thereby, achieving power efficient and reliable delivery of the MBS services. The timer(s) include at least one of the drx-onDurationTimerPTM, the drx-Inactivity TimerPTM and the drx-RetransmissionTimerDL-PTM.

In an embodiment, when the value carried by the DRXᵢ is equal to 1 but the index i is not configured for the UE (100), then the MAC entity of the UE (100) can ignore the reception of the DRX command.

Moreover, the number of simultaneously configurable and receivable MBS services for the UE is dependent on the UE capability.

FIG. 4 is an example of the MBS DRX Command MAC CE (420) based on the bitmap using the eLCID (410b), according to the embodiments as disclosed herein.

In an embodiment, Non-zero-byte MAC CE (420) using the eLCID (410b): Considering a scenario where the MAC CE (420) determined as the MBS DRX command issued to the UE (100) by the network apparatus is the non-zero-byte, i.e. the MBS DRX command includes both the MAC subheader (410) and the MAC CE (420). The MAC subheader (410) has own LCID (410a) and/or the eLCID (410b). The eLCID (410b) extends the range of the LCID (410a). The LCID/eLCID value identifies the logical channel instance of the corresponding MAC SDU or the type of the corresponding MAC CE. As described in FIG. 3, the MAC CE (420) is transmitted to the UE (100) via the PTM transmission/retransmission by one of the G-RNTI, the MBS Semi-Persistent Scheduling (SPS) or the G-CS-RNTI. The MAC CE (420) can also be transmitted to the UE (100) via the PTP transmission/retransmission by the C-RNTI, the unicast SPS or the CS-RNTI.

In an embodiment, the MAC CE (420) to be transmitted to the UE (100) is determined as the DRX command when the DRX index (DRXᵢ) of the MAC CE (420) corresponds to the DRX configuration of the MBS service, where the index is defined as ‘i’. The index i is configured by the RRC signaling such that the mapping exists between the index i and the G-RNTI/G-CS-RNTI or the MBS DRX configuration. Alternatively, the index i can be configured as an ascending order of the configured G-RNTI/G-CS-RNTI or the configured multicast assignment G-RNTI/G-CS-RNTI. Further, the MAC CE (420) to be transmitted to the UE (100) is determined as the DRX command when the value carried by the DRXᵢ is equal to 1. When the value carried by the DRXᵢ is equal to 0, then the MAC CE (420) is not considered as the DRX command for the G-RNTI/G-CS-RNTI.

Upon determining that the DRX index of the MAC CE (420) corresponds to the DRX configuration of the MBS service and the value carried by the DRX index of the MAC CE (420) is equal to 1, the MAC CE (420) is transmitted as the DRX command to the UE (100). The DRX command is transmitted to the UE (100) to stop the respective timer of the DRX configuration for the MBS service of the UE (100), in order to activate the sleep mode in the UE (100) when the UE (100) is not in use. Thereby, achieving power efficient and reliable delivery of the MBS services. The timer(s) include at least one of the drx-onDurationTimerPTM, the drx-Inactivity TimerPTM and the drx-Retransmission TimerDL-PTM.

In an embodiment, when the value carried by the DRXi is equal to 1 but the index i is not configured for the UE (100), then the MAC entity of the UE (100) can ignore the reception of the DRX command.

FIG. 5 is an example of the MBS DRX Command MAC CE (520) based on the G-RNTI (520a)/G-CS-RNTI using the LCID (510a), according to the embodiments as disclosed herein.

In an embodiment, Single G-RNTI format using the LCID (510a): Considering a scenario where the MAC CE (520) determined as the MBS DRX command issued to the UE (100) by the network apparatus is the non-zero-byte, i.e. the MBS DRX command includes the MAC subheader (510) and the MAC CE (520). The MAC subheader (510) has own LCID value for determining the service (unicast or MBS) transmission to the UE (100). The MAC CE (520) includes the G-RNTI (520a). As described in FIG. 3, the MAC CE (520) is transmitted to the UE (100) via the PTM transmission/retransmission by one of the G-RNTI (520a), the MBS Semi-Persistent Scheduling (SPS) or the G-CS-RNTI. The MAC CE (520) can also be transmitted to the UE (100) via the PTP transmission/retransmission by the C-RNTI, the unicast SPS or the CS-RNTI.

In an embodiment, the MAC CE (520) to be transmitted to the UE (100) is determined as the DRX command when the G-RNTI (520a) and/or the G-CS-RNTI is included in the MAC CE (520). The G-RNTI (520a) and/or the G-CS-RNTI is an identifier which is allocated by a Public Land Mobile Network (PLMN) and is unique within the PLMN.

Upon determining that the G-RNTI (520a) and/or the G-CS-RNTI is included in the MAC CE (520), the MAC CE (520) is transmitted as the DRX command to the UE (100). The DRX command is transmitted to the UE (100) to stop the respective timer of DRX configuration of the MBS service, in order to activate the sleep mode in the UE (100) when the UE (100) is not in use. Thereby, achieving power efficient and reliable delivery of the MBS services. The timer(s) include at least one of the drx-onDurationTimerPTM, the drx-Inactivity TimerPTM and the drx-RetransmissionTimerDL-PTM.

If the MAC CE (520) includes the G-RNTI (520a) and/or the G-CS-RNTI which is not configured by the UE (100), then the MAC entity of the UE (100) can ignore the MAC CE (520).

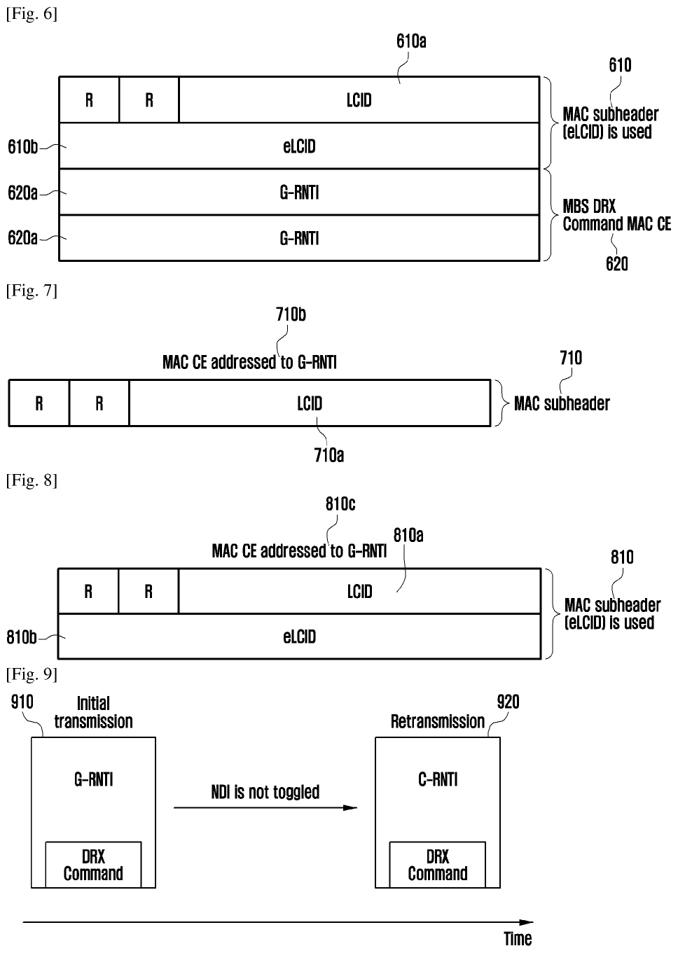

FIG. 6 is an example of the MBS DRX Command MAC CE (620) based on the G-RNTI (620a) and/or the G-CS-RNTI using the eLCID (610b), according to the embodiments as disclosed herein.

In an embodiment, Single G-RNTI format using the eLCID (610b): Considering a scenario where the MAC CE (620) determined as the MBS DRX command issued to the UE (100) by the network apparatus is the non-zero-byte, i.e. the MBS DRX command includes the MAC subheader (610) and the MAC CE (620). The MAC subheader (610) has own LCID/eLCID value. The LCID/eLCID value identifies the logical channel instance of the corresponding MAC SDU or the type of the corresponding MAC CE. The MAC CE (620) includes the G-RNTI (620a) and/or the G-CS-RNTI. As described in FIG. 3, the MAC CE (620) is transmitted to the UE (100) via the PTM transmission/retransmission by one of the G-RNTI (620a), the MBS Semi-Persistent Scheduling (SPS) or the G-CS-RNTI. The MAC CE (620) can also be transmitted to the UE (100) via the PTP transmission/retransmission by the C-RNTI, the unicast SPS or the CS-RNTI.

In an embodiment, the MAC CE (620) to be transmitted to the UE (100) is determined as the DRX command when the G-RNTI (620a) and/or the G-CS-RNTI is the MAC CE (620). Upon determining that the G-RNTI (620a) and/or the G-CS-RNTI is included in the MAC CE (620), the MAC CE (620) is transmitted as the DRX command to the UE (100). The DRX command is transmitted to the UE (100) to stop the respective timer of DRX configuration of the MBS service, in order to activate the sleep mode in the UE (100) when the UE (100) is not in use. Thereby, achieving power efficient and reliable delivery of the MBS services.

If the MAC CE (620) includes the G-RNTI (620a) and/or the G-CS-RNTI which is not configured by the UE (100), then the MAC entity of the UE (100) can ignore the MAC CE (620).

FIG. 7 is an example of the MBS DRX Command MAC CE (520) indicated by the PDCCH addressed to the G-RNTI (710b) and/or the G-CS-RNTI or by a configured downlink multicast assignment and using the LCID (710a), according to the embodiments as disclosed herein.

In an embodiment, considering a scenario where the zero-byte MAC CE determined as the DRX command is issued by the network apparatus to the UE (100). The DRX command for the DRX configuration of the G-RNTI (710b) or the G-CS-RNTI. The MAC CE is identified as the DRX command for the DRX configuration of the G-RNTI (710b) or the G-CS-RNTI, when the MAC CE is included by a MAC Protocol Data Unit (PDU) is addressed or scheduled by one of the G-RNTI (710b), the G-CS-RNTI and the configured downlink multicast assignment.

In an embodiment, the DRX command is identified and transmitted from the network apparatus to the UE (100) for stopping the respective timer of DRX configuration of the MBS service using the Channel ID (i.e. LCID 710a). When the MAC CE is identified as the DRX command for the DRX configuration of the G-RNTI (710b) or the G-CS-RNTI, the UE (100) stops the at least one timer of the DRX configuration for the G-RNTI (710b) or the G-CS-RNTI. The timer(s) include at least one of the drx-onDurationTimerPTM, the drx-InactivityTimer PTM and the drx-RetransmissionTimerDL-PTM.

FIG. 8 is an example of the MBS DRX Command MAC CE indicated by PDCCH addressed to the G-RNTI (810c) and/or the G-CS-RNTI or by the configured downlink multicast assignment and using the eLCID (810b), according to the embodiments as disclosed herein.

In an embodiment, considering a scenario where the zero-byte MAC CE determined as the DRX command is issued by the network apparatus to the UE (100). The DRX command for the DRX configuration of the G-RNTI (810c) or the G-CS-RNTI. The MAC CE is identified as the DRX command for the DRX configuration of the G-RNTI (810c) or the G-CS-RNTI, when the MAC CE is included by the MAC PDU is addressed or scheduled by one of the G-RNTI (810c), the G-CS-RNTI and the configured downlink multicast assignment.

In an embodiment, the DRX command is identified and transmitted from the network apparatus to the UE (100) for stopping the respective timer of DRX configuration of the MBS service using the Channel ID (i.e. eLCID (810b)). When the MAC CE is identified as the DRX command for the DRX configuration of the G-RNTI (810c) or the G-CS-RNTI, the UE (100) stops the at least one timer of the DRX configuration for the G-RNTI (810c) or the G-CS-RNTI. The timer(s) include at least one of the drx-onDurationTimerPTM, the drx-InactivityTimerPTM and the drx-RetransmissionTimerDL-PTM.

FIG. 9 is an example of the MBS DRX Command MAC CE across an initial transmission addressed to the G-RNTI (910) and/or the G-CS-RNTI and retransmission addressed to the C-RNTI (920) and/or the CS-RNTI, according to the embodiments as disclosed herein.

In an embodiment, considering a scenario where the zero-byte MAC CE determined as the DRX command is issued by the network apparatus to the UE (100). The DRX command for the DRX configuration of the G-RNTI (910), the G-CS-RNTI, the C-RNTI (920) and the CS-RNTI vary. The DRX command is identified as follows:
1. The MAC CE is identified as the DRX command for the DRX configuration of the G-RNTI (910) or the G-CS-RNTI, when the MAC CE is included by the MAC PDU addressed or scheduled by one of the C-RNTI (920), the CS-RNTI and the configured downlink assignment, and the DRX command is transmitted as a retransmission of the PTM transmission with the G-RNTI (910) or the G-CS-RNTI. The DRX command is transmitted as the retransmission of the PTM transmission with the G-RNTI (910) or the G-CS-RNTI when a New Data Indicator (NDI) is not toggled for the C-RNTI (920), and the latest NDI is toggled by the G-RNTI (910) or the G-CS-RNTI.
2. The MAC CE is identified as the DRX command for the DRX configuration of the C-RNTI (920) or the CS-RNTI, when the MAC CE is included by the MAC PDU addressed or scheduled by one of the C-RNTI (920), the CS-RNTI and the configured downlink assignment, and the DRX command is transmitted as an initial transmission or retransmission with the C-RNTI (920). The DRX command is transmitted as the initial transmission or the retransmission with the C-RNTI (920), when the NDI is toggled for the C-RNTI (920), or the NDI has not been toggled for the C-RNTI (920) but the latest NDI has been toggled by the same C-RNTI (920).

In an embodiment, the DRX command is identified and transmitted from the network apparatus to the UE (100) for stopping the respective timer of DRX configuration of the MBS service using the Channel ID. When the MAC CE is identified as the DRX command for the DRX configuration of the G-RNTI (910) or the G-CS-RNTI and when it is retransmitted addressed or scheduled by C-RNTI or CS-RNTI, the UE (100) does not stop the at least one timer for the DRX configuration of the G-RNTI (910) or the G-CS-RNTI. The timer(s) include at least one of the drx-onDurationTimerPTM, the drx-InactivityTimerPTM and the drx-RetransmissionTimerDL-PTM.

In an embodiment, when the MAC CE is identified as the DRX command for the unicast DRX configuration, the UE (100) stops the respective timer of the DRX configuration for a DRX group of the unicast. The timer(s) include at least one of the drx-onDurationTimer, the drx-InactivityTimer and the drx-RetransmissionTimerDL.

In another embodiment, the DRX command for the MBS can be a Short DRX command or a Long DRX command, where each of the Short DRX command and the Long DRX command is identified by a distinct LCID and/or eLCID. The difference in the operation is that when the UE (100) receives the Short DRX command, if short DRX cycle is configured for the MBS, the UE (100) uses a short DRX cycle; else, the UE (100) uses a long DRX cycle. When the UE (100) receives the long DRX command, the UE (100) uses the long DRX cycle. The Short DRX cycle or the long DRX cycle can be configured to the UE (100) through a drx-ConfigPTM for a concerned G-RNTI and/or the G-CS-RNTI configuration e.g. in a MAC-CellGroupConfig for a cell group for the UE (100). Configuration of the Short DRX cycle or the long DRX cycle is made as per latency requirement for the MBS service and usage of the Short DRX command or the Long DRX command to facilitate dynamic transitions across the short DRX cycle and the long DRX cycle with changing service requirements.

In an embodiment, upon reception of the DRX command for the MBS, the UE (100) stops the timers for the concerned G-RNTI (910) and/or the G-CS-RNTI. In case all the PTM timers for all the configured G-RNTIs (910) and/or the G-CS-RNTIs for the UE (100) are stopped and the UE (100) is no longer in an active time for any of the G-RNTIs (910), the UE (100) does not report Channel State Information (CSI) and/or Sounding Reference Signal (SRS), when reporting is not required as per unicast DRX operation (e.g. as per Active Time of the unicast DRX). Otherwise, the UE (100) continues reporting the CSI and/or the SRS.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) for managing a Discontinuous reception (DRX) operation, the method comprising:
receiving, from a base station, configuration information on a first DRX configuration associated with a group radio network temporary identifier (G-RNTI) and a second DRX configuration associated with a cell radio network temporary identifier (C-RNTI);
obtaining a DRX command medium access control (MAC) control element (CE);
identifying whether the DRX command MAC CE is obtained based on the G-RNTI or whether the DRX command MAC CE is obtained based on the C-RNTI; and
in case that the DRX command MAC CE is obtained based on the G-RNTI, applying the first DRX configuration associated with the G-RNTI.

2. The method of claim 1,
wherein a DRX command MAC CE obtained based on the C-RNTI is for unicast and not a retransmission of the point-to-multipoint (PTM) transmission associated with G-RNTI.

3. The method of claim 1, applying the first DRX configuration associated with the G-RNTI further comprising:
stopping drx-ondurataiontimerPTM of the DRX for the G-RNTI; and
stopping drx-inactivitytimerPTM of the DRX for the G-RNTI.

4. The method of claim 1,
in case that the DRX command MAC CE is obtained based on the C-RNTI, applying the second DRX configuration associated with the C-RNTI.

5. The method of claim 4, applying the second DRX configuration associated with the C-RNTI further comprising:
stopping drx-ondurataiontimer for a DRX group; and
stopping drx-inactivitytimer for the DRX group.

6. The method of claim 1,
wherein the DRX command MAC CE is included in a MAC protocol data unit (PDU),
wherein the DRX command MAC CE is zero-byte,
wherein the first DRX configuration includes at least one of drx-onDurationTimerPTM, drx-InactivityTimerPTM, and drx-RetransmissionTimerDL-PTM, and
wherein the second DRX configuration includes at least one of drx-onDurationTimer, drx-InactivityTimer, and drx-RetransmissionTimerDL.

7. A method performed by a base station for managing a Discontinuous reception (DRX) operation, the method comprising:
transmitting, to a terminal, configuration information on a first DRX configuration associated with a group radio network temporary identifier (G-RNTI) and a second DRX configuration associated with a cell radio network temporary identifier (C-RNTI);
in case that a DRX operation of the terminal is for the first DRX configuration associated with the G-RNTI, transmitting a first DRX command medium access control (MAC) control element (CE) based on the G-RNTI; and
in case that a DRX operation of the terminal is for the second DRX configuration associated with the C-RNTI, transmitting a second DRX command MAC CE based on the C-RNTI.

8. The method of claim 7,
wherein the first DRX configuration includes at least one of drx-onDurationTimerPTM, drx-InactivityTimerPTM, and drx-RetransmissionTimerDL-PTM, and
wherein the second DRX configuration includes at least one of drx-onDurationTimer, drx-InactivityTimer, and drx-RetransmissionTimerDL.

9. A user equipment (UE) in a wireless communication system for managing a Discontinuous reception (DRX) operation, the UE comprising:
a transceiver configured to transmit and receive a signal; and
a controller coupled with the transceiver and configured to:
receive, from a base station, configuration information on a first DRX configuration associated with a group radio network temporary identifier (G-RNTI) and a second DRX configuration associated with a cell radio network temporary identifier (C-RNTI);
obtain a DRX command medium access control (MAC) control element (CE);
identify whether the DRX command MAC CE is obtained based on the G-RNTI or whether the DRX command MAC CE is obtained based on the C-RNTI; and
in case that the DRX command MAC CE is obtained based on the G-RNTI, apply the first DRX configuration associated with the G-RNTI.

10. The UE of claim 9,
wherein a DRX command MAC CE obtained based on the C-RNTI is for unicast and not a retransmission of the point-to-multipoint (PTM) transmission associated with G-RNTI.

11. The UE of claim 9, the processor is further configured to:
stopping drx-ondurataiontimerPTM of the DRX for the G-RNTI; and
stopping drx-inactivitytimerPTM of the DRX for the G-RNTI.

12. The UE of claim 9, the processor is further configured to apply the second DRX configuration associated with the C-RNTI, in case that the DRX command MAC CE is obtained based on the C-RNTI,
wherein applying the second DRX configuration associated with the C-RNTI further comprises stopping drx-ondurataiontimer for a DRX group and stopping drx-inactivitytimer for the DRX group.

13. The UE of claim 9,
wherein the DRX command MAC CE is included in a MAC protocol data unit (PDU),
wherein the DRX command MAC CE is zero-byte,
wherein the first DRX configuration includes at least one of drx-onDurationTimerPTM, drx-InactivityTimerPTM, and drx-RetransmissionTimerDL-PTM, and
wherein the second DRX configuration includes at least one of drx-onDurationTimer, drx-InactivityTimer, and drx-RetransmissionTimerDL.

14. A base station in a wireless communication system for managing a Discontinuous reception (DRX) operation, the base station comprising:
a transceiver configured to transmit and receive a signal; and
a controller coupled with the transceiver and configured to:
transmit, to a terminal, configuration information on a first DRX configuration associated with a group radio network temporary identifier (G-RNTI) and a second DRX configuration associated with a cell radio network temporary identifier (C-RNTI);
in case that a DRX operation of the terminal is for the first DRX configuration associated with the G-RNTI, transmit a first DRX command medium access control (MAC) control element (CE) based on the G-RNTI; and
in case that a DRX operation of the terminal is for the second DRX configuration associated with the C-RNTI, transmit a second DRX command MAC CE based on the C-RNTI.

15. The base station of claim 14,
wherein the first DRX configuration includes at least one of drx-onDurationTimerPTM, drx-InactivityTimerPTM, and drx-RetransmissionTimerDL-PTM, and
wherein the second DRX configuration includes at least one of drx-onDurationTimer, drx-InactivityTimer, and drx-RetransmissionTimerDL.
